(19) United States
(12) Patent Application Publication
(10) Pub. No.: US 2024/0204946 A1
(43) Pub. Date: Jun. 20, 2024

(54) Data Transmission Method and Device

(71) Applicant: VIVO MOBILE COMMUNICATION CO., LTD., Dongguan (CN)

(72) Inventors: Yannan Yuan, Dongguan (CN); Xiaodong Yang, Dongguan (CN); Chenlu Zhang, Dongguan (CN)

(21) Appl. No.: 18/592,945

(22) Filed: Mar. 1, 2024

Related U.S. Application Data
(63) Continuation of application No. PCT/CN2022/115874, filed on Aug. 30, 2022.

(30) Foreign Application Priority Data
Sep. 2, 2021 (CN) 202111028766.7

(51) Int. Cl. H04L 5/00; H04L 69/22; H04W 28/06

(52) U.S. Cl. CPC H04L 5/0048; H04L 69/22; H04W 28/06

(57) ABSTRACT

A data transmission method includes adding, by a first function, first header information to target data; and sending, by the first function, the target data to the 1st network function indicated by the first header information. The first header information is used for indicating at least one of the following: one or more network functions used for processing the target data, or a sequence of a plurality of network functions used for processing the target data.

### CROSS-REFERENCE TO RELATED APPLICATIONS

This application is a Bypass Continuation Application of International Patent Application No. PCT/CN2022/115874, filed Aug. 30, 2022, and claims priority to Chinese Patent Application No. 202111028766.7, filed Sep. 2, 2021, the disclosures of which are hereby incorporated by reference in their entireties.

### BACKGROUND OF THE INVENTION

### Field of the Invention

This application pertains to the field of communications technologies, and in particular, to a data transmission method and a device, where the device may include a data transmission apparatus, a terminal, a network side device, and the like.

### Description of Related Art

In the communications technology, when data is transmitted inside the receive end or the transmit end, for the receive end, the data is usually transmitted and processed by each protocol layer in an ascending order. For example, after being processed by the physical layer, the data is transmitted to the medium access control (MAC) layer for processing, after being processed by the MAC layer, the data is transmitted to the radio link control (RLC) layer for processing, after being processed by the RLC layer, the data is transmitted to the packet data convergence protocol (PDCP) layer for processing, and the like. For the transmit end, the data is usually transmitted and processed by each protocol layer in a descending order.

### SUMMARY OF THE INVENTION

According to a first aspect, a data transmission method is provided, including: adding, by a first function, first header information to target data, where the first header information is used for indicating at least one of the following: one or more network functions used for processing the target data, or a sequence of a plurality of network functions used for processing the target data; and sending, by the first function, the target data to the 1st network function indicated by the first header information.

According to a second aspect, a data transmission method is provided, including: receiving, by a target network function, target data, where the target data includes first header information, and the first header information is used for indicating at least one of the following: one or more network functions used for processing the target data, or a sequence of a plurality of network functions used for processing the target data; and processing, by the target network function, the target data.

According to a third aspect, a data transmission apparatus is provided, including: an adding module, configured to add first header information to target data, where the first header information is used for indicating at least one of the following: one or more network functions used for processing the target data, or a sequence of a plurality of network functions used for processing the target data; and a sending module, configured to send the target data to the 1st network function indicated by the first header information.

According to a fourth aspect, a data transmission apparatus is provided, including: a receiving module, configured to receive target data, where the target data includes first header information, and the first header information is used for indicating at least one of the following: one or more network functions used for processing the target data, or a sequence of a plurality of network functions used for processing the target data; and a processing module, configured to process the target data.

According to a fifth aspect, a terminal is provided. The terminal includes a processor, a memory, and a program or an instruction stored in the memory and executable on the processor, where when the program or the instruction is executed by the processor, the method according to the first aspect or the second aspect is implemented.

According to a sixth aspect, a terminal is provided, including a processor and a communications interface, where the processor is configured to add first header information to target data, where the first header information is used for indicating at least one of the following:

one or more network functions used for processing the target data, or a sequence of a plurality of network functions used for processing the target data; and the communications interface is configured to send the target data to the 1st network function indicated by the first header information; or the communications interface is configured to receive target data, where the target data includes first header information, and the first header information is used for indicating at least one of the following: one or more network functions used for processing the target data, or a sequence of a plurality of network functions used for processing the target data; and the processor is configured to process the target data.

According to a seventh aspect, a network side device is provided. The network side device includes a processor, a memory, and a program or an instruction stored in the memory and executable on the processor, and when the program or the instruction is executed by the processor, the method according to the first aspect or the second aspect is implemented.

According to an eighth aspect, a network side device is provided, including a processor and a communications interface, where the processor is configured to add first header information to target data, where the first header information is used for indicating at least one of the following: one or more network functions used for processing the target data, or a sequence of a plurality of network functions used for processing the target data; and the communications interface is configured to send the target data to the 1st network function indicated by the first header information; or the communications interface is configured to receive target data, where the target data includes first header information, and the first header information is used for indicating at least one of the following: one or more network functions used for processing the target data, or a sequence of a plurality of network functions used for processing the target data; and the processor is configured to process the target data.

According to a ninth aspect, a non-transitory readable storage medium is provided. The non-transitory readable storage medium stores a program or an instruction, and when the program or the instruction is executed by a processor, the method according to the first aspect or the second aspect is implemented.

According to a tenth aspect, a chip is provided, the chip includes a processor and a communications interface, the communications interface is coupled to the processor, and the processor is used to run a program or an instruction, to implement the method according to the first aspect or the second aspect.

According to an eleventh aspect, a computer program/program product is provided, where the computer program/program product is stored in a non-transitory storage medium, and the program/program product is executed by at least one processor to implement the method according to the first aspect or the second aspect.

### BRIEF DESCRIPTION OF THE DRAWINGS

FIG. 1 is a schematic diagram of a wireless communications system according to an embodiment of this application;

FIG. 2 is a schematic flowchart of a data transmission method according to an embodiment of this application;

FIG. 3 is a schematic flowchart of a data transmission method according to an embodiment of this application;

FIG. 4 is a schematic diagram of a data transmission method according to an embodiment of this application;

FIG. 5 is a schematic diagram of a configuration information obtaining approach according to an embodiment of this application;

FIG. 6 is a schematic diagram of a configuration information obtaining approach according to an embodiment of this application;

FIG. 7 is a schematic diagram of a structure of a data transmission apparatus according to an embodiment of this application;

FIG. 8 is a schematic diagram of a structure of a data transmission apparatus according to an embodiment of this application;

FIG. 9 is a schematic diagram of a structure of a communications device according to an embodiment of this application;

FIG. 10 is a schematic diagram of a structure of a terminal according to an embodiment of this application; and

FIG. 11 is a schematic diagram of a structure of a network side device according to an embodiment of this application.

### DESCRIPTION OF THE INVENTION

The following clearly describes technical solutions in embodiments of this application with reference to accompanying drawings in the embodiments of this application. Apparently, the described embodiments are some but not all of the embodiments of this application. All other embodiments obtained by a person of ordinary skill in the art based on the embodiments of this application shall fall within the protection scope of this application.

The terms “first”, “second”, and the like in this specification and claims of this application are used to distinguish between similar objects instead of describing a specific order or sequence. It should be understood that, the terms used in such a way is interchangeable in proper circumstances, so that the embodiments of this application can be implemented in an order other than the order illustrated or described herein. Objects classified by “first” and “second” are usually of a same type, and the number of objects is not limited. For example, there may be one or more first objects. In addition, in the specification and the claims, “and/or” represents at least one of connected objects, and the character “/” generally represents an “or” relationship between associated objects.

It should be noted that, the technologies described in the embodiments of this application are not limited to a Long Term Evolution (LTE)/LTE-Advanced (LTE-A) system, and can also be used in other wireless communications systems such as Code Division Multiple Access (CDMA), Time Division Multiple Access (TDMA), Frequency Division Multiple Access (FDMA), Orthogonal Frequency Division Multiple Access (OFDMA), Single-carrier Frequency-Division Multiple Access (SC-FDMA), and another system. The terms “system” and “network” in the embodiments of this application may be used interchangeably. The technologies described can be applied to both the systems and the radio technologies mentioned above as well as to other systems and radio technologies. The following describes a New Radio (NR) system for example purposes, and NR terms are used in most of the following descriptions. These technologies can also be applied to applications other than an NR system application, such as a 6th generation (6G) communications system.

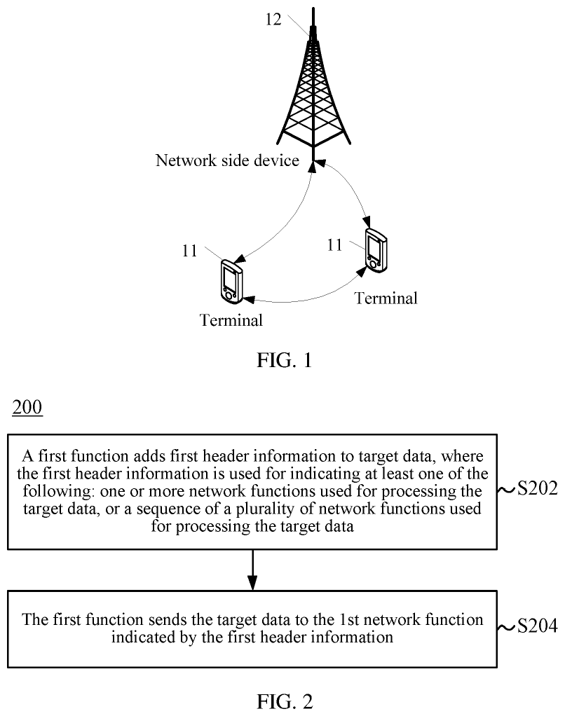

FIG. 1 is a schematic diagram of a wireless communications system to which an embodiment of this application can be applied. The wireless communications system includes a terminal 11 and a network side device 12. The terminal 11 may also be referred to as a terminal device or user equipment (UE). The terminal 11 may be a terminal side device such as a mobile phone, a tablet personal computer, a laptop computer or a notebook computer, a personal digital assistant (PDA), a palmtop computer, a netbook, an ultra-mobile personal computer (UMPC), a mobile Internet device (MID), an augmented reality (AR)/virtual reality (VR) device, a robot, a wearable device, vehicle user equipment (VUE), pedestrian user equipment (PUE), smart household (household devices with wireless communications functions, such as a refrigerator, a television, a washing machine, or furniture), and the wearable device include a smart watch, a smart band, a smart headphone, smart glasses, smart jewelry (a smart bracelet, a smart hand chain, a smart ring, a smart necklace, a smart bangle, a smart anklet, or the like), a smart wristband, smart clothes, a game console, and the like. It should be noted that a type of the terminal 11 is not limited in the embodiments of this application. The network side device 12 may be a base station or a core network. The base station may be referred to as an access point, a base transceiver station (BTS), a radio base station, a radio transceiver, a basic service set (BSS), an extended service set (ESS), a Node B, an evolved NodeB (eNB), a next generation NodeB (gNB), a home NodeB, a home evolved NodeB, a WLAN access point, a Wi-Fi node, a transmission reception point (TRP), or another appropriate term in the art. As long as the same technical effect is achieved, the base station is not limited to a specific technical term. It should be noted that the base station in the NR system is taken only as an example in the embodiments of this application, but a type of the base station is not limited.

Usually, because a processing sequence for each protocol layer is fixed, flexibility of data transmission is poor, for example, the data transmission scheme cannot be customized based on the terminal characteristics, and it cannot adapt well to the development direction of the future service architecture.

The following describes, in detail, the data transmission method and a device provided in the embodiments of this application through some embodiments and application scenarios thereof with reference to the accompanying drawings.

As shown in FIG. 2, an embodiment of this application provides a data transmission method 200. The method may be performed by a first function. The first function can be a network function entity or the like, and the method may include the following steps.

S202: A first function adds first header information to target data, where the first header information is used for indicating at least one of the following: one or more network functions used for processing the target data, or a sequence of a plurality of network functions used for processing the target data.

In this embodiment, the first function may be located inside the transmit end; or the first function and the transmit end are two independent network functions, and the first function assists the transmit end in transmitting data. The transmit end can be a terminal, a network side device, or the like.

In this embodiment, the first header information can be used to indicate which network functions are required at the transmit end and/or the receive end to process the target data, and can also indicate the sequence of the plurality of network functions, that is, the processing sequence for the target data.

In an example, the first header information is used for indicating the following two items: a plurality of network functions used for processing the target data, and a sequence of the plurality of network functions used for processing the target data. For example, a format of the first header information is as follows: {NF 1, NF 2, NF 3}. In this way, for the transmit end, the target data can be sent to the NF 1 after the first function adding the first header information to the target data, the target data can be sent to the NF 2 after being processed by the NF 1, the target data can be sent to the NF 3 after being processed by the NF 2, and the target data can be sent to the physical layer after being processed by the NF 3, where the physical layer can be indicated by the first header information or can also be preset. For the receive end, the target data can be sent to the NF 3 after being processed by the physical layer of the receive end, the target data can be sent to the NF 2 after being processed by the NF 3, and the target data can be sent to the NF 1 after being processed by the NF 2.

In another example, the first header information is used for indicating one or more network functions for processing the target data, and when there are a plurality of network functions, a sequence of the plurality of network functions may be predefined.

In still another example, the first header information is used for indicating the sequence of the plurality of network functions for processing the target data. Certainly, this example is equivalent to indicating, by default, the plurality of network functions for processing the target data.

S204: The first function sends the target data to the 1st network function indicated by the first header information.

In this embodiment, after the first network function processes the target data, the target data can be sent, based on the indication of the first header information, to the 2nd network function indicated by the first header information, thus realizing the processing and transmission of the target data.

According to the data transmission method provided in this embodiment of this application, the first function may add first header information to target data, where the first header information is used for indicating at least one of the following: one or more network functions used for processing the target data, or a sequence of a plurality of network functions used for processing the target data. In this way, the target data can be transmitted based on the indication of the first header information, thus realizing a wireless service scheme which has no data bearing and no protocol layer and can be customized in the terminal, and improving the flexibility of data transmission.

It is mentioned in the method 200 that the first function adds the first header information to the target data. Optionally, the first function may add the first header information to the target data based on configuration information, and the configuration information includes at least one of the following.
1) Radio function chain adding list, including one or more radio function chains, where each radio function chain can include one or more network functions.

The adding list may be an initial list or a list added on the basis of the initial list.
2) Radio function chain deleting/release list, including one or more radio function chains, where each radio function chain can include one or more network functions.

Each radio function chain mentioned above can be used for indicating at least one of the following: one or more network functions used for processing the target data, or a sequence of a plurality of network functions used for processing the target data, that is, the first header information in S202 may include one radio function chain.

The radio function chain mentioned above may also include one or more pieces of the following information:
1) identity of target data, where the identity is used for indicating data required to be processed by the first function, and can be indicated by at least one of the following: user equipment identity (ID), protocol data unit (PDU), session identity, QoS flow identity (QFI), Internet protocol (IP) address, or medium access control (MAC) address;
2) description information of the radio function chain, where the description information is used to describe the function and the sequence of the radio function chain. For example, the transmit end is {NF 1, NF 2, NF 3}, and the receive end is {NF 3, NF 2, NF 1}; and
3) identity of a physical layer network function, where the identity is used for indicating a physical layer network function of the target data in air interface transmission. Optionally, this information is not required if there is only one physical layer network function; and if there are a plurality of physical layer network functions, when there is no such information, a default physical layer network function is used.

In a process of processing the target data by the network function indicated by the first header information, the first header information may meet at least one of the following that:
1) the first header information is at the header of the target data; or
2) content of the first header information is not changed.

For example, the first header information is prepositional and invariable, that is, when the network function of the transmit end does not process (or change) the first header information and keeps sending the first header information to a next network function, the first header information is still at the header position of the target data, which is convenient for the network function to parse.

For the receive end, the receive end may or may not change the first header information. For example, an indication format of the first header information is as follows: {NF 1, NF 2, NF 3}. For the receive end, the target data can be sent to the NF 3 after being processed by the physical layer network function, the target data can be sent to the NF 2 after being processed by the NF 3, and the target data can be sent to the NF 1 after being processed by the NF 2. The NF 3 can delete the NF 3 in the first header information during processing, and the NF 2 can delete the NF 2 and the NF 3 in the first header information during processing.

In addition, in the process of processing the target data by the network function indicated by the first header information, the first header information meets the preposition and invariance. However, for the physical layer network function or other network functions, the target data may not have the first header information.

In an example, the first header information may include at least one of the following 1) to 4).
1) Plurality of network functions for processing the target data and the sequence of the plurality of network functions in the receive end and/or the transmit end. In this embodiment, a length of this field can be determined based on a limit of a maximum number of network functions, a mutual exclusion and cooperation relationship between network functions, and a representation method.

For example, the maximum number of network functions is 15, and the maximum number of network functions used at a time is 8 considering mutual exclusion and cooperation. If hexadecimal is used for representation, the length of this field can be represented by 32 bits, and every 4 bits represent one network function (when it is 0, it means none). The order from high to low is the sequence of the transmit end, and the order from low to high is the sequence of the receive end (or vice versa). Then 0049AF indicates that in the receive end, a network function F needs to perform processing first, the second is a network function A, the third is a network function 9, and the fourth is a network function 4. It can also indicate that in the transmit end, the network function 4 needs to perform processing first, the second is the network function 9, the third is the network function A, and the fourth is the network function F.
2) Identity of a physical layer network function, where the identity is used for indicating a physical layer network function of the target data in air interface transmission. This identity can be referred to as a source physical layer network function identity, the identity is a destination physical layer network function identity from the processing of the transmit end, and the identity is the source physical layer network function identity from the processing of the receive end. The identity indicates the physical layer network function of the target data in air interface transmission, such as a 5G physical layer network function, a 6G physical layer network function, a WIFI 6 physical layer network function, and the like.
3) Length information, where the length information is used for indicating a length of the first header information. In this embodiment, the length of this field can be determined based on a maximum header length limit and a unit of the header length. For example, the maximum header length is 32 bytes, and the unit of the header length is bytes (indicating that a minimum unit of length change is 1 byte), then the first header information can be represented by 5 bits.
4) Protocol version information, where the protocol version information is used for indicating a protocol version defined by the network function, such as R18.

As for the configuration information mentioned in the above embodiments, the following will introduce three ways to obtain the configuration information.

In an example, the first function obtains the configuration information, where the first function is located at the network side, and the configuration information is generated by a decision of a network control plane; or the first function is located at the terminal side, and the configuration information is generated by a decision of the terminal, such as being generated by an independent decision of the terminal.

In another example, the first function obtains first header information in data, where the data is received in a case that the first function is used as a receive end; and the first function obtains the configuration information based on the obtained first header information. For example, if the first header information in the target data A received by the communications device (in this case, the receive end) includes {NF 1, NF 2, NF 3}, then the communications device obtains the configuration information based on {NF 1, NF 2, NF 3}, and the communications device (in this case, the transmit end) can add the first header information {NF 1, NF 2, NF 3} when sending the target data B, where the target data A and the target data B may have a same PDU session identity, QFI, or the like.

In still another example, the first function receives the configuration information, where the first function is located at a terminal side, and the configuration information is sent by a network side.

In this embodiment, the configuration information further includes at least one of the following: 1) indication information for indicating whether the first header information exists; or 2) a data radio bearer (DRB) identity, where the DRB identity is valid in a case that the first header information does not exist.

Optionally, the configuration information includes indication information for indicating that the first header information does not exist, and also includes a DRB identity. Then, the first function can perform transmission based on the data transmission manner in the communications technology. For example, at the receive end, data is transmitted and processed by each protocol layer in an ascending order; and at the transmit end, data is transmitted and processed by each protocol layer in a descending order.

In this embodiment, the indication information in the configuration information is used to indicate whether the first header information exists, so that the embodiments of this application can be well compatible with the data transmission method in the communications technology, and the communications efficiency can be improved.

In the foregoing examples, the configuration information may be configured based on at least one of the following granularities: a terminal, a protocol data unit (PDU) session, a quality of service (QoS) flow, a service, an Internet protocol (IP) address, or a media access control (MAC) address.

The following separately describes the data transmission method in detail provided in the embodiments of this application by using the transmit end and the receive end.

The transmit end may be a network side device or a terminal.
1. The first function adds, based on received configuration information or preset radio function chain information, the first header information to the target data from at least one of the following: a configured PDU session, a QoS flow, an IP address (a source address and/or a destination address), or a MAC address.

The first header information is prepositional and invariable, that is, when the network function of the transmit end does not process the first header information, and the first header information is still at the header position when being kept to be sent to a next network function. The first function sends the target data added with the first header information to the 1st network function in a network function sequence of the transmit end based on the sequence of the network functions on the transmit end.
2. The first network function sends processed target data to the 2nd network function in the network function sequence of the transmit end while maintaining the preposition and invariance of the first header information, and so on.
3. If a specific network function is the last network function in the network function sequence of the transmit end, the network function sends processed target data to the destination physical layer network function based on a destination physical layer network function identity, and the target data is a transport block of the destination physical layer network function.

The receive end may be a network device or a terminal.
1. The physical layer network function on the receive end receives the target data with the first header information, where a reverse order of the network function sequence on the transmit end is the network function sequence on the receive end, and then the physical layer network function on the receive end sends the processed target data to the first network function in the network function sequence of the receive end.
2. The first network function sends processed target data to the 2nd network function in the network function sequence of the receive end while maintaining the preposition and invariance of the first header information, and so on.
3. If a specific network function is the last network function in the network function sequence of the receive end, the network function sends the processed target data to a core network network function and/or an application layer function based on an interface definition of a radio access network function.

According to the data transmission method provided in this embodiment of this application, the first function adds the first header information to the target data based on the configuration information, to support a flexible combination of QoS granularity and user plane wireless function, and realize a wireless service scheme which has no data bearing and no protocol layer and can be customized in the terminal.

For a case that a user plane processing requirement change rapidly and dynamically or the QoS granularity is small (such as the IP address), the process such as DRB establishment can be avoided, and the number of DRBs is not limited, thus improving the data transmission efficiency. Without the above requirements, this embodiment of this application can be compatible with the existing scheme, and the flexibility of data transmission is improved.

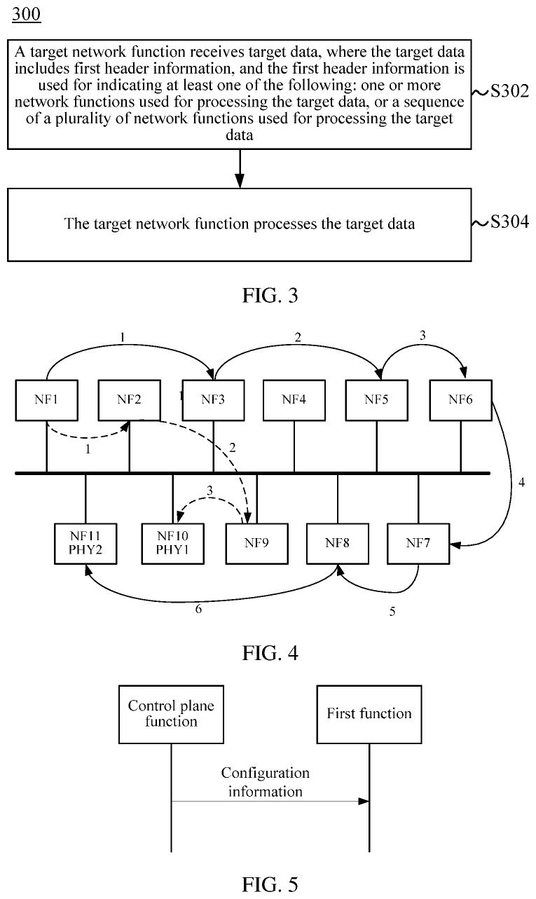

The data transmission method according to this embodiment of this application is described above in detail with reference to FIG. 2. A data transmission method according to another embodiment of this application is described in detail below with reference to FIG. 3. It can be understood that the description on the network function side is the same as that on the first function side in the method shown in FIG. 2, and therefore related description is appropriately omitted to avoid repetition.

FIG. 3 is a schematic flowchart of implementing a data transmission method according to an embodiment of this application. The method may be applied to a network side device. As shown in FIG. 3, the method 300 includes the following steps.

S302: A target network function receives target data, where the target data includes first header information, and the first header information is used for indicating at least one of the following: one or more network functions used for processing the target data, or a sequence of a plurality of network functions used for processing the target data.

S304: The target network function processes the target data.

The target network function mentioned in this embodiment may be one of one or more network functions indicated by the first header information, and the target network function does not include the physical layer network function.

According to the data transmission method provided in this embodiment of this application, the target data received by the target network function includes first header information, and the first header information is used for indicating at least one of the following: one or more network functions used for processing the target data, or a sequence of a plurality of network functions used for processing the target data. In this way, the target data can be transmitted based on the indication of the first header information, thus realizing a wireless service scheme which has no data bearing and no protocol layer and can be customized in the terminal, and improving the flexibility of data transmission.

Optionally, in an embodiment, the first header information includes at least one of the following:
1) identity of a physical layer network function, where the identity is used for indicating a physical layer network function of the target data in air interface transmission;
2) length information, where the length information is used for indicating a length of the first header information; or
3) protocol version information, where the protocol version information is used for indicating a protocol version defined by the network function.

Optionally, in an embodiment, in a process of processing the target data by the network function indicated by the first header information, the first header information meets at least one of the following: the first header information is at the header of the target data; or content of the first header information is not changed.

Optionally, in an embodiment, the processing, by the target network function, the target data includes at least one of the following:
1) sending, by the target network function, the target data to a next network function after the target network function indicated by the first header information;
2) sending, by the target network function, the target data to an upper application of the target network function;
3) sending, by the target network function, the target data to a core network through an interface between a radio access network and the core network; or
4) sending, by the target network function, the target data to the physical layer network function.

In order to describe the data transmission method provided in this embodiment of this application in detail, the following will use several embodiments for description.

### Embodiment 1

Embodiment 1 provides a wireless service combination scheme based on user plane header information. In this embodiment, as shown in FIG. 4, the radio protocol configuration function (RPCF) (the NF 1 in FIG. 4) corresponds to the first function in the foregoing embodiment, the network functions numbered 2 to 11 are only examples of network functions, and the serial numbers do not represent relationships between network functions or the order of processing.

The NF 2 can be a header compression/decompression function, the NF 3 can be a ciphering and deciphering function, the NF 4 can be an integrity protection/verification function, the NF 5 can be a segmentation/reassembly function, the NF 6 can be an error correction through ARQ function, the NF 7 can be a multiplexing/demultiplexing function, the NF 8 can be an error correction through HARQ function, the NF 9 can be a scheduling/priority handing function, the NF 10 can be a first physical layer, and the NF 11 can be a second physical layer.

This embodiment can be applied to 6G, and the network function of 6G can also include other network functions (such as a digital twinning function, a sensing function, and the like) or combinations of example network functions (such as combining the NF 2, the NF 3, and the NF 4 into the PDCP function).

In addition, each of the above network functions can be respectively carried by one entity communications device, or a plurality of network functions can be carried by one entity communications device.

In this embodiment, the configuration information received by the RPCF includes a radio function chain adding list, and the list includes the following two radio function chains:
1) identity of target data: UEID+PDU session ID+QFI; description information of the radio function chain: {NF 3, NF 5, NF 6, NF 1, NF 8}; an identity of the destination physical layer network function: PHY 2 or NF 11; and
2) identity of target data: an IP address (source address+destination address); description information of the radio function chain: {NF 2, NF 9}; an identity of the destination physical layer network function: PHY 1 or NF 10.

Next, the related steps are briefly described by using the transmit end and the receive end.

The steps of the transmit end can be seen in FIG. 4, details are as follows.

Based on the two configured radio function chains, the RPCF adds the first header information to the data with a data identity of UEID+PDU session ID+QFI and IP address (source address+destination address) separately, and sends the processed data unit to the first network function in the network function sequence of the transmit end. That is, the processed data with a data identity of UEID+PDU session ID+QFI is sent to the NF 3; and the processed data with a data identity of IP address (source address+destination address) is sent to the NF 2.

The NF 3 and the NF 2 separately process the received data in parallel under the constraint of the preposition and invariance of the first header information, and the processed data are separately sent to the NF 5 and the NF 9, and so on.

When the last network function, namely, the NF 8 or the NF 9 in the network function sequence of the transmit end completes the function processing under the constraint of the preposition and invariance of the first header information, the NF 8 sends the data to the PHY 2, and the NF 9 sends the data to the PHY 1 as transport blocks of corresponding physical layer network functions respectively. Finally, after being processed by the physical layer network function, the data is sent to the receive end through the air interface.

For the steps at the receive end, the PHY 1 is used as an example as below, and because the PHY 2 is similar to that, details are not described herein again.

The reverse order of the network function sequence of the transmit end is the network function sequence of the receive end, and the physical layer network function of the receive end, that is, the PHY 1 sends the processed data to the first network function in the network function sequence of the receive end, that is, the NF 9.

The NF 9 sends processed data to the 2nd network function NF 2 in the network function sequence of the receive end while maintaining the preposition and invariance of the first header information.

The NF 2 is the last processing function in the network function sequence of the receive end. The NF 2 sends the data to the core network through the interface between the radio access network and the core network, or the NF 2 sends the data to the upper application.

### Embodiment 2

This embodiment provides a configuration scheme for the first function.

For the network side, as shown in FIG. 5, the configuration information of the first function is determined and generated by the network control plane function. If evolving based on 5G architecture, the first function can be configured through an E1 interface between CU-CP and CU-UP. If a service interface is used between the control plane function that generates the configuration information and the first function, the configuration information can support the configuration through the service interface of the control plane function, and the first function is a consumer of the configuration information. See the description of other embodiments for the configuration information. For downlink, the network side is the transmit end of Embodiment 1, and the terminal is the receive end of Embodiment 1. After the network side completes the configuration, the terminal side only needs to process based on the first header information of the received data.

For the terminal side, the existing protocol does not define the interface between processing functions of the terminal side. Therefore, for the terminal, in the foregoing network side scenario, the configuration information belonging to the first function can be decided and generated by the terminal. Self-determination of the terminal is mainly used when the network side has not configured the first function for the terminal side. For uplink, the terminal is the transmit end of Embodiment 1, and the network side is the receive end of Embodiment 1. The first function of the terminal side performs uplink data processing based on the configuration information decided by the terminal, and the network side performs processing based on the first header information of the received data.

### Embodiment 3

This embodiment provides another configuration scheme for the first function.

If the receive end supports association/reflection of received network processing chain information to corresponding network processing chain information for transmitting, the configuration scheme of the first function is the association/reflection configuration based on the received information. Under this configuration scheme, the receive end supports the above association/reflection configuration, which includes the following content.

When the network side or the terminal acts as the receive end, when the receive end processes, the target physical layer in the received first header information, or the last network function processed by the receive end, or one of the processing functions needs to send the header information to the first function.

The first function associates/maps the received network processing chain information into the configuration information of the first function required for transmission.

The first function uses the manner in Embodiment 1 for data processing and air interface interaction.

### Embodiment 4

This embodiment provides still another configuration scheme for the first function.

For uplink, when the terminal is the transmit end, a configuration scheme of the first function at the terminal side is that the network side sends the configuration information to the terminal. The terminal processes an uplink signal based on the received configuration information, and the network side processes the receive end based on the first header information of the received data.

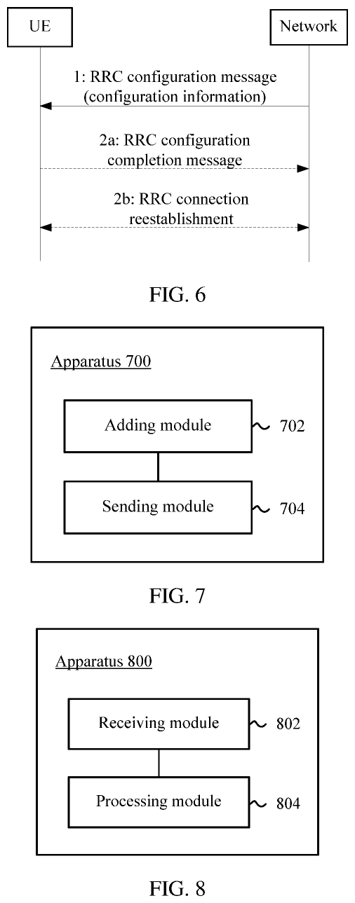

As shown in FIG. 6, one manner in which the network side sends the configuration information to the terminal is to configure through a radio resource control (RRC) reconfiguration procedure. In this case, the network side can send an RRC configuration message to the terminal, the RRC configuration message includes the configuration information. When completing the configuration, the terminal can feed back an RRC configuration completion message to the network, or when the configuration fails, the terminal can initiate an RRC connection reestablishment process to the network to re-obtain the configuration information.

For the configuration information in this embodiment, refer to the descriptions of other embodiments, and in addition, the configuration information can further include one or more of the following items:
1) indication of the existence of the downlink first header information: for example, 0 means no existence, and 1 means existence;
2) indication of the existence of the uplink first header information: for example, 0 means no existence, and 1 means existence; and
3) DRB-identity: this information is valid when the uplink and/or downlink first header information does not exist. When the wireless service scheme based on the first header information is not used, this embodiment can be compatible with the existing scheme of transmission based on the protocol layer.

It should be noted that, the data transmission method provided in this embodiment of this application may be performed by a data transmission apparatus or a control module that is in the data transmission apparatus and that is configured to perform the data transmission method. In this embodiment of this application, the data transmission apparatus provided in this embodiment of this application is described by using an example in which the data transmission apparatus performs the data transmission method.

FIG. 7 is a schematic diagram of a structure of a data transmission apparatus according to an embodiment of this application. The apparatus may correspond to the first function in another embodiment. As shown in FIG. 7, an apparatus 700 includes the following modules:
an adding module 702, configured to add first header information to target data, where the first header information is used for indicating at least one of the following: one or more network functions used for processing the target data, or a sequence of a plurality of network functions used for processing the target data; and
a sending module 704, configured to send the target data to the 1st network function indicated by the first header information.

According to the data transmission apparatus provided in this embodiment of this application, the adding module may add first header information to target data, where the first header information is used for indicating at least one of the following: one or more network functions used for processing the target data, or a sequence of a plurality of network functions used for processing the target data. In this way, the target data can be transmitted based on the indication of the first header information, thus realizing a wireless service scheme which has no data bearing and no protocol layer and can be customized in the terminal, and improving the flexibility of data transmission.

Optionally, in an embodiment, the first header information includes at least one of the following:
1) identity of a physical layer network function, where the identity is used for indicating a physical layer network function of the target data in air interface transmission;
2) length information, where the length information is used for indicating a length of the first header information; or
3) protocol version information, where the protocol version information is used for indicating a protocol version defined by the network function.

Optionally, in an embodiment, in a process of processing the target data by the network function indicated by the first header information, the first header information meets at least one of the following that: the first header information is at the header of the target data; or content of the first header information is not changed.

Optionally, in an embodiment, the adding module 702 is configured to add the first header information to the target data based on configuration information; and the configuration information includes at least one of the following: a radio function chain adding list or a radio function chain deleting/release list, where the radio function chain includes one or more network functions.

Optionally, in an embodiment, the radio function chain further includes at least one of the following: an identity of the target data, description information of the radio function chain, or an identity of the physical layer network function.

Optionally, in an embodiment, the apparatus further includes an obtaining module, configured to obtain the configuration information, where the apparatus is located at a network side, and the configuration information is generated by a decision of a network control plane; or the apparatus is located at a terminal side, and the configuration information is generated by a decision of the terminal.

Optionally, in an embodiment, the apparatus further includes an obtaining module, configured to: obtain first header information in data, where the data is received in a case that the apparatus is used as a receive end; and obtain the configuration information based on the obtained first header information.

Optionally, in an embodiment, the apparatus further includes a receiving module, configured to receive the configuration information, where the apparatus is located at a terminal side, and the configuration information is sent by a network side.

Optionally, in an embodiment, the configuration information further includes at least one of the following: 1) indication information for indicating whether the first header information exists; or 2) a DRB identity, where the DRB identity is valid in a case that the first header information does not exist.

Optionally, in an embodiment, the configuration information is configured based on at least one of the following granularities: a terminal, a PDU session, a QoS flow, a service, an IP address, or a MAC address.

The apparatus 700 according to this embodiment of this application may correspond to the procedures of the method 200 in the embodiments of this application, and the units/modules in the apparatus 700 and the foregoing operations and/or functions are separately for implementing the corresponding procedures of the method 200, and can achieve a same or equivalent technical effect. For brevity, details are not described herein again.

The data transmission apparatus in this embodiment of this application may be an apparatus or an apparatus or electronic device with an operating system, or may be a component, an integrated circuit, or a chip in a terminal. The apparatus or electronic device may be a mobile terminal, or a non-mobile terminal. For example, the mobile terminal may include but is not limited to the types of the foregoing listed terminal 11, and the non-mobile terminal may be a server, a network attached storage (NAS), a personal computer (PC), a television (TV), a teller machine, or a self-service machine. This is not limited in this embodiment of this application.

The data transmission apparatus provided in this embodiment of this application can implement the processes implemented in the method embodiments in FIG. 2 to FIG. 6, with the same technical effect achieved. To avoid repetition, details are not described herein again.

FIG. 8 is a schematic diagram of a structure of a data transmission apparatus according to an embodiment of this application. The apparatus may correspond to the network function in another embodiment. As shown in FIG. 8, an apparatus 800 includes the following modules:
a receiving module 802, configured to receive target data, where the target data includes first header information, and the first header information is used for indicating at least one of the following: one or more network functions used for processing the target data, or a sequence of a plurality of network functions used for processing the target data; and
a processing module 804, configured to process the target data.

According to the data transmission apparatus provided in this embodiment of this application, the target data received by the receiving module includes first header information, where the first header information is used for indicating at least one of the following: one or more network functions used for processing the target data, or a sequence of a plurality of network functions used for processing the target data. In this way, the target data can be transmitted based on the indication of the first header information, thus realizing a wireless service scheme which has no data bearing and no protocol layer and can be customized in the terminal, and improving the flexibility of data transmission.

Optionally, in an embodiment, the first header information includes at least one of the following:
1) identity of a physical layer network function, where the identity is used for indicating a physical layer network function of the target data in air interface transmission;
2) length information, where the length information is used for indicating a length of the first header information; or
3) protocol version information, where the protocol version information is used for indicating a protocol version defined by the network function.

Optionally, in an embodiment, in a process of processing the target data by the network function indicated by the first header information, the first header information meets at least one of the following that: the first header information is at the header of the target data; or content of the first header information is not changed.

Optionally, in an embodiment, the processing module 804 is configured for at least one of the following:
1) sending the target data to a next network function after the apparatus indicated by the first header information;
2) sending the target data to an upper application;
3) sending the target data to a core network through an interface between a radio access network and the core network; or
4) sending the target data to the physical layer network function.

The apparatus 800 according to this embodiment of this application may correspond to the procedures of the method 300 in the embodiments of this application, and the units/modules in the apparatus 800 and the foregoing operations and/or functions are separately for implementing the corresponding procedures of the method 300, and can achieve a same or equivalent technical effect. For brevity, details are not described herein again.

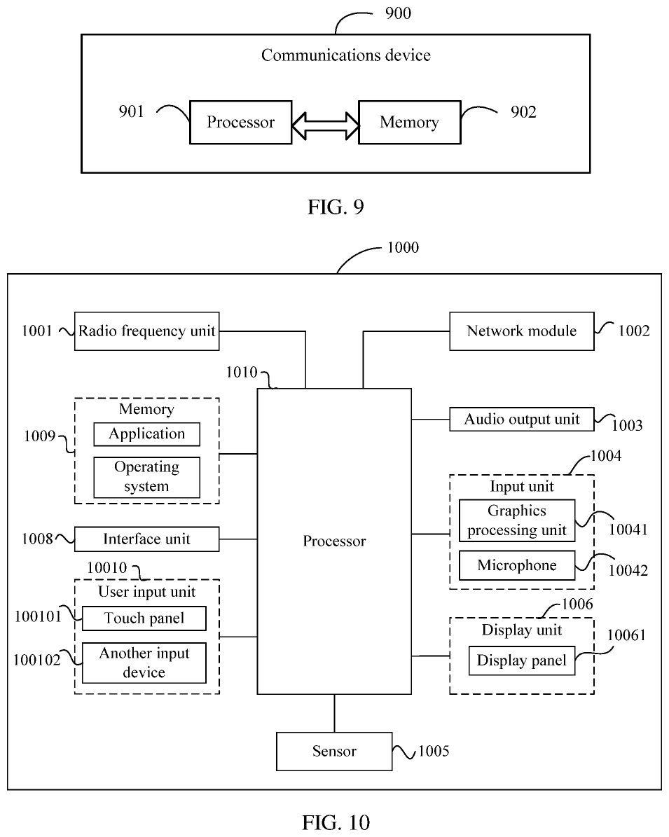

Optionally, as shown in FIG. 9, an embodiment of this application further provides a communications device 900, including a processor 901, a memory 902, and a program or an instruction stored in the memory 902 and executable on the processor 901. For example, in a case that the communications device 900 is a terminal, when the program or the instruction is executed by the processor 901, the processes of the foregoing data transmission method embodiment are implemented, with the same technical effects achieved. In a case that the communications device 900 is a network side device, when the program or the instruction is executed by the processor 901, the processes of the foregoing data transmission method embodiment are implemented, with the same technical effects achieved. To avoid repetition, details are not repeated herein.

An embodiment of this application further provides a terminal, including a processor and a communications interface, where the processor is configured to add first header information to target data, where the first header information is used for indicating at least one of the following: one or more network functions used for processing the target data, or a sequence of a plurality of network functions used for processing the target data; and the communications interface is configured to send the target data to the 1st network function indicated by the first header information; or the communications interface is configured to receive target data, where the target data includes first header information, and the first header information is used for indicating at least one of the following: one or more network functions used for processing the target data, or a sequence of a plurality of network functions used for processing the target data; and the processor is configured to process the target data.

This terminal embodiment corresponds to the foregoing method embodiment on the terminal side. Each implementation process and implementation of the foregoing method embodiment may be applicable to this terminal embodiment, and a same technical effect can be achieved. For example, FIG. 10 is a schematic diagram of a hardware structure of a terminal according to an embodiment of this application.

A terminal 1000 includes but is not limited to at least a part of components such as a radio frequency unit 1001, a network module 1002, an audio output unit 1003, an input unit 1004, a sensor 1005, a display unit 1006, a user input unit 1007, an interface unit 1008, a memory 1009, and a processor 1010.

A person skilled in the art can understand that the terminal 1000 may further include a power supply (such as a battery) that supplies power to each component. The power supply may be logically connected to the processor 1010 by using a power supply management system, to implement functions such as charging and discharging management, and power consumption management by using the power supply management system. The terminal structure shown in FIG. 10 constitutes no limitation on the terminal, and the terminal may include more or fewer components than those shown in the figure, or combine some components, or have different component arrangements. Details are not described herein.

It should be understood that, in this embodiment of this application, the input unit 1004 may include a graphics processing unit (GPU) 10041 and a microphone 10042, and the graphics processing unit 10041 processes image data of a still picture or a video obtained by an image capture apparatus (such as a camera) in a video capture mode or an image capture mode. The display unit 1006 may include a display panel 10061. Optionally, the display panel 10061 may be configured in a form such as a liquid crystal display or an organic light-emitting diode. The user input unit 1007 includes a touch panel 10071 and another input device 10072. The touch panel 10071 is also referred to as a touchscreen. The touch panel 10071 may include two parts: a touch detection apparatus and a touch controller. The another input device 10072 may include but is not limited to a physical keyboard, a functional button (such as a volume control button or a power on/off button), a trackball, a mouse, and a joystick. Details are not described herein.

In this embodiment of this application, the radio frequency unit 1001 receives downlink data from a network side device and then sends the downlink data to the processor 1010 for processing; and sends uplink data to the network side device. Usually, the radio frequency unit 1001 includes but is not limited to an antenna, at least one amplifier, a transceiver, a coupler, a low noise amplifier, a duplexer, and the like.

The memory 1009 may be configured to store a software program or an instruction and various data. The memory 1009 may mainly include a program or instruction storage area and a data storage area. The program or instruction storage area may store an operating system, an application or an instruction required by at least one function (for example, a sound playing function or an image playing function), and the like. In addition, the memory 1009 may include a high-speed random access memory, and may further include a non-transitory memory. The non-transitory memory may be a read-only memory (ROM), a programmable read-only memory (PROM), an erasable programmable read-only memory (EPROM), an electrically erasable programmable read-only memory (EEPROM), or a flash memory, for example, at least one disk storage device, a flash memory device, or another non-transient solid-state storage device.

The processor 1010 may include one or more processing units. Optionally, an application processor and a modem processor may be integrated into the processor 1010. The application processor mainly processes an operating system, a user interface, an application, an instruction, or the like. The modem processor mainly processes wireless communication, for example, a baseband processor. It may be understood that, alternatively, the modem processor may not be integrated into the processor 1010.

The processor 1010 is configured to add first header information to target data, where the first header information is used for indicating at least one of the following: one or more network functions used for processing the target data, or a sequence of a plurality of network functions used for processing the target data; and the radio frequency unit 1001 is configured to send the target data to the 1st network function indicated by the first header information.

Alternatively, the radio frequency unit 1001 is configured to receive target data, where the target data includes first header information, and the first header information is used for indicating at least one of the following: one or more network functions used for processing the target data, or a sequence of a plurality of network functions used for processing the target data; and the processor 1010 is configured to process the target data.

In this embodiment of this application, the target data includes first header information, where the first header information is used for indicating at least one of the following: one or more network functions used for processing the target data, or a sequence of a plurality of network functions used for processing the target data. In this way, the target data can be transmitted based on the indication of the first header information, thus realizing a wireless service scheme which has no data bearing and no protocol layer and can be customized in the terminal, and improving the flexibility of data transmission.

The terminal 1000 provided in this embodiment of this application can implement the processes of the forgoing data transmission method embodiment, and achieve a same technical effect. To avoid repetition, details are not described herein again.

An embodiment of this application further provides a network side device, including a processor and a communications interface, where the processor is configured to add first header information to target data, where the first header information is used for indicating at least one of the following: one or more network functions used for processing the target data, or a sequence of a plurality of network functions used for processing the target data; and the communications interface is configured to send the target data to the 1st network function indicated by the first header information; or the communications interface is configured to receive target data, where the target data includes first header information, and the first header information is used for indicating at least one of the following: one or more network functions used for processing the target data, or a sequence of a plurality of network functions used for processing the target data; and the processor is configured to process the target data.

The network side device embodiment corresponds to the foregoing method embodiment of the network side device. Each implementation process and implementation of the foregoing method embodiment may be applicable to the network side device embodiment, and a same technical effect can be achieved.

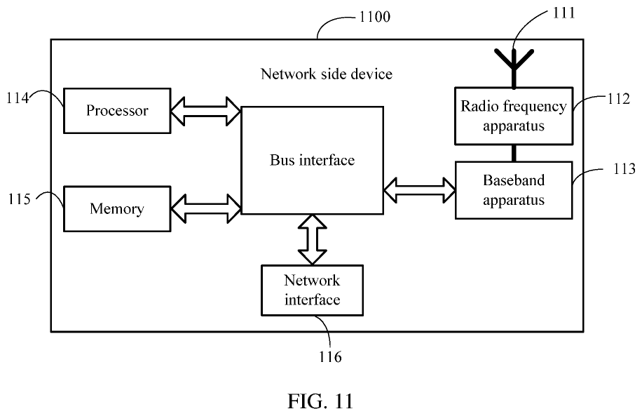

Optionally, an embodiment of this application further provides a network side device. As shown in FIG. 11, a network side device 1100 includes an antenna 111, a radio frequency apparatus 112, and a baseband apparatus 113. The antenna 111 is connected to the radio frequency apparatus 112. In an uplink direction, the radio frequency apparatus 112 receives information by using the antenna 111, and sends the received information to the baseband apparatus 113 for processing. In a downlink direction, the baseband apparatus 113 processes information that needs to be sent, and sends processed information to the radio frequency apparatus 112. The radio frequency apparatus 112 processes the received information, and sends processed information by using the antenna 111.

The frequency band processing apparatus may be located in the baseband apparatus 113. The method performed by the network side device in the foregoing embodiment may be implemented in the baseband apparatus 113. The baseband apparatus 113 includes a processor 114 and a memory 115.

The baseband apparatus 113 may include, for example, at least one baseband board, where a plurality of chips are disposed on the baseband board. As shown in FIG. 11, one chip is, for example, the processor 114, which is connected to the memory 115, so as to invoke a program in the memory 115 to perform operations of the network side device shown in the foregoing method embodiment.

The baseband apparatus 113 may further include a network interface 116, configured to exchange information with the radio frequency apparatus 112. For example, the interface is a common public radio interface (CPRI).

For example, the network side device in this embodiment of this application further includes an instruction or a program stored in the memory 115 and executable on the processor 114. The processor 114 invokes the instruction or the program in the memory 115 to perform the method performed by the modules shown in FIG. 7 or FIG. 8, and a same technical effect is achieved. To avoid repetition, details are not described herein again.

An embodiment of this application further provides a non-transitory readable storage medium. The non-transitory readable storage medium stores a program or an instruction. When the program or the instruction is executed by a processor, the processes in the foregoing data transmission method embodiments are implemented, and a same technical effect can be achieved. To avoid repetition, details are not described herein again.

The processor is the processor in the terminal described in the above embodiment. The non-transitory readable storage medium includes a non-transitory computer-readable storage medium, such as a computer read-only memory (ROM), a random access memory (RAM), a magnetic disk, or an optical disc.

An embodiment of this application further provides a chip. The chip includes a processor and a communications interface, the communications interface is coupled to the processor, and the processor is configured to run a program or an instruction to implement processes of the embodiment of the data transmission method, and a same technical effect can be achieved. To avoid repetition, details are not described herein again.

It should be understood that the chip mentioned in this embodiment of this application may also be referred to as a system-level chip, a system chip, a chip system, or a system on chip.

An embodiment of this application also provides a computer program product. The computer program product is stored in a non-volatile memory, and the computer program product is executed by at least one processor to implement the processes of the embodiment of the data transmission method, and a same technical effect can be achieved. To avoid repetition, details are not described herein again.

An embodiment of this application further provides a communications device, configured to perform the processes of the embodiment of the data transmission method, and a same technical effect can be achieved. To avoid repetition, details are not described herein again.

It should be noted that, in this specification, the term “include”, “comprise”, or any other variant thereof is intended to cover a non-exclusive inclusion, so that a process, a method, an article, or an apparatus that includes a list of elements not only includes those elements but also includes other elements which are not expressly listed, or further includes elements inherent to this process, method, article, or apparatus. In absence of more constraints, an element preceded by “includes a . . . ” does not preclude the existence of other identical elements in the process, method, article, or apparatus that includes the element. In addition, it should be noted that the scope of the method and the apparatus in the implementations of this application is not limited to performing functions in an illustrated or discussed sequence, and may further include performing functions in a basically simultaneous manner or in a reverse sequence according to the functions concerned. For example, the described method may be performed in an order different from that described, and the steps may be added, omitted, or combined. In addition, features described with reference to some examples may be combined in other examples.

Based on the descriptions of the foregoing implementations, a person skilled in the art may clearly understand that the method in the foregoing embodiment may be implemented by software in addition to a necessary universal hardware platform or by hardware only. Based on such an understanding, the technical schemes of this application essentially or the part contributing to the prior art may be implemented in a form of a computer software product. The computer software product is stored in a storage medium (such as a ROM/RAM, a hard disk, or an optical disc), and includes several instructions for instructing a terminal (which may be a mobile phone, a computer, a server, an air conditioner, a network side device, or the like) to perform the methods described in the embodiments of this application.

The embodiments of this application are described above with reference to the accompanying drawings, but this application is not limited to the foregoing implementations, and the foregoing implementations are only illustrative and not restrictive. Under the enlightenment of this application, a person of ordinary skill in the art can make many forms without departing from the purpose of this application and the protection scope of the claims, all of which fall within the protection of this application.

What is claimed is:

1. A data transmission method, comprising:
adding, by a first function, first header information to target data, wherein the first header information is used for indicating at least one of the following: one or more network functions used for processing the target data, or a sequence of a plurality of network functions used for processing the target data; and
sending, by the first function, the target data to the 1st network function indicated by the first header information.

2. The method according to claim 1, wherein the first header information comprises at least one of the following:
an identity of a physical layer network function, wherein the identity is used for indicating a physical layer network function of the target data in air interface transmission;
length information, wherein the length information is used for indicating a length of the first header information; or
protocol version information, wherein the protocol version information is used for indicating a protocol version defined by a network function.

3. The method according to claim 1, wherein in a process of processing the target data by a network function indicated by the first header information, the first header information meets at least one of the following that:
the first header information is at a header of the target data; or
content of the first header information is not changed.

4. The method according to claim 1, wherein the adding, by a first function, first header information to target data comprises: adding, by the first function, the first header information to the target data based on configuration information; and
the configuration information comprises at least one of the following: a radio function chain adding list or a radio function chain deleting list, wherein the radio function chain comprises one or more network functions.

5. The method according to claim 4, wherein the radio function chain further comprises at least one of the following:
an identity of the target data, description information of the radio function chain, or an identity of a physical layer network function.

6. The method according to claim 4, wherein the method further comprises: obtaining, by the first function, the configuration information, wherein
the first function is located at a network side, and the configuration information is generated by a decision of a network control plane; or
the first function is located at a terminal side, and the configuration information is generated by a decision of a terminal.

7. The method according to claim 4, wherein the method further comprises:
obtaining, by the first function, first header information in data, wherein the data is received in a case that the first function is used as a receive end; and
obtaining, by the first function, the configuration information based on the obtained first header information.

8. The method according to claim 4, wherein the method further comprises: receiving, by the first function, the configuration information, wherein
the first function is located at a terminal side, and the configuration information is sent by a network side.

9. The method according to claim 8, wherein the configuration information further comprises at least one of the following:
indication information for indicating whether the first header information exists; or
a data radio bearer (DRB) identity, wherein the DRB identity is valid in a case that the first header information does not exist.

10. The method according to claim 4, wherein the configuration information is configured based on at least one of the following granularities: a terminal, a protocol data unit (PDU) session, a quality of service (QoS) flow, a service, an Internet protocol (IP) address, or a media access control (MAC) address.

11. A data transmission method, comprising:
receiving, by a target network function, target data, wherein the target data comprises first header information, and the first header information is used for indicating at least one of the following: one or more network functions used for processing the target data, or a sequence of a plurality of network functions used for processing the target data; and
processing, by the target network function, the target data.

12. The method according to claim 11, wherein the first header information comprises at least one of the following:
an identity of a physical layer network function, wherein the identity is used for indicating a physical layer network function of the target data in air interface transmission;
length information, wherein the length information is used for indicating a length of the first header information; or
protocol version information, wherein the protocol version information is used for indicating a protocol version defined by a network function.

13. The method according to claim 11, wherein in a process of processing the target data by a network function indicated by the first header information, the first header information meets at least one of the following that:
the first header information is at a header of the target data; or
content of the first header information is not changed.

14. The method according to claim 11, wherein the processing, by the target network function, the target data comprises at least one of the following:
sending, by the target network function, the target data to a next network function after the target network function indicated by the first header information;
sending, by the target network function, the target data to an upper application of the target network function;
sending, by the target network function, the target data to a core network through an interface between a radio access network and the core network; or
sending, by the target network function, the target data to a physical layer network function.

15. A terminal, comprising a processor, a memory, and a program or an instruction stored in the memory and executable on the processor, wherein the program or the instruction, when executed by the processor, causes the terminal to perform:
adding first header information to target data, wherein the first header information is used for indicating at least one of the following: one or more network functions used for processing the target data, or a sequence of a plurality of network functions used for processing the target data; and
sending the target data to the 1st network function indicated by the first header information.

16. The terminal according to claim 15, wherein the first header information comprises at least one of the following:
an identity of a physical layer network function, wherein the identity is used for indicating a physical layer network function of the target data in air interface transmission;
length information, wherein the length information is used for indicating a length of the first header information; or
protocol version information, wherein the protocol version information is used for indicating a protocol version defined by a network function.

17. The terminal according to claim 15, wherein in a process of processing the target data by a network function indicated by the first header information, the first header information meets at least one of the following that:
the first header information is at a header of the target data; or
content of the first header information is not changed.

18. A terminal, comprising a processor, a memory, and a program or an instruction stored in the memory and executable on the processor, wherein when the program or the instruction is executed by the processor, the data transmission method according to claim 11 is implemented.

19. A network side device, comprising a processor, a memory, and a program or an instruction stored in the memory and executable on the processor, wherein when the program or the instruction is executed by the processor, the data transmission method according to claim 1 is implemented.

20. A network side device, comprising a processor, a memory, and a program or an instruction stored in the memory and executable on the processor, wherein when the program or the instruction is executed by the processor, the data transmission method according to claim 11 is implemented.
